(19) United States
(12) Patent Application Publication
(10) Pub. No.: US 2008/0175359 A1
(43) Pub. Date: Jul. 24, 2008

(54) SYSTEM AND METHOD FOR CONTROLLING THE OPERATING STATES OF AN APPLICATION

(76) Inventor: Daniel David Karmazyn, Toronto (CA)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 12/013,004

(22) Filed: Jan. 11, 2008

(30) Foreign Application Priority Data
Jan. 12, 2007 (CA) 2,573,914

(51) Int. Cl. H04M 11/00; G06F 9/54

(52) U.S. Cl. 379/93.01; 719/318

(57) ABSTRACT

System and methods are provided that permit the operating state of a software application to be controlled with a single button on a keyboard. Data may be stored that associate the application's operating states with predetermined successor states. In response to operation of the key, the current operating state of the application is identified, a corresponding successor state is identified, and the application is placed in the successor states. This arrangement reduces reliance on a mouse to select menu commands or the need to memorize keyboard equivalents and reduces the complexity of keyboards.

This non-provisional application claims benefit of Canadian Application 2,573,914 which was filed on Jan. 12, 2007.

### FIELD OF THE INVENTION

The invention relates generally to computing devices, and more specifically, to system and method for controlling the operating states of an application.

### BACKGROUND

FIGS. 1a-d depict simulated screen shots of Windows XP™. Applications that are compliant with the Windows XP™ operating system have certain operating states in common, namely, a non-operative state, a foreground state, a background state, and a minimized state. In a non-operative state, an application typically resides in a storage device, such as a hard disc drive, and has not been launched. In a foreground state, as exemplified in FIG. 1a, an application has an open window 10, which may overlay and obscure windows associated with other applications, such as the window 11. Most significantly, in the foreground state, keystrokes and mouse clicks are directed to the application for processing. In a background state of operation, as exemplified in FIG. 1b, windows associated with other applications, such as the window 11, may overlay the application's window 10. The menu bar associated with the application's window 10 is then dimmed (not shown) to suggest an inactive state, and keystrokes, mouse clicks and, more generally, input/output operations are no longer directed to the application but to whatever application is then in the foreground. In a minimized state, as exemplified in FIG. 1c, the window 10 and any other windows associated with the application are hidden, which facilitates access to windows associated with other applications previously operating in the background. The application remains launched but this is apparent only from an identification 12 of the application (the word “application” in FIG. 1c) in a screen area referred to as the “tool bar” and indicated with reference numeral 13 in FIGS. 1a-1d. In an alternative minimized state shown in FIG. 1d, some applications are identified in what is referred to as the “XP system tray” indicated with the reference number 14. A fictitious application icon 15 consisting of two intersecting ellipses has been shown in the XP system tray 14 to exemplify how an application associated with such an icon 15 would be identified in the XP tray 14.

Various user actions place a software application in its different operating states. When the user launches the application, as by clicking on an application icon, the operating system activates the application and places it in its foreground state. Launching another application, clicking in a window associated with another application, or clicking on the name of another application in the tool bar 13 incidentally places the application in its background state. When in the background state, clicking in the application window or clicking on the representation 12 of the application in the tool bar 13 brings the application to its foreground state. In the foreground state, clicking on a minimize button 16 associated with the application window 10 places the application in its minimized state. Thereafter clicking on the application's name 12 in the tool bar 13 returns the application to its foreground state. Clicking on an X-button 17 associated with the application window 10 will cause the application to return to its inoperative foreground state although some applications may remain referenced in the XP tray 14 (unless specific steps are taken to quit) in which case clicking on the icon representing an application in the XP system tray (such as the icon 15) brings the application to the foreground.

There are shortcomings associated with such operation, which include time delays occasioned by manipulating a mouse and incidental diversion of a user's attention from work in progress. To avoid the delay and distraction occasioned by use of a mouse, many computer users prefer to use what are referred to as “keyboard equivalents” or “short cuts.” Keyboard equivalents often involve pressing an alphanumeric key contemporaneously with one or more modifiers keys, such as command, control, shift and alt/option keys, to invoke a desired menu command or to mimic the effect of clicking on a button. It is also known practice to associate application commands with a set of function keys so that clicking each function key triggers a different operation. A shortcoming associated with keyboard equivalents is the need to memorize what key has been assigned to what function.

To facilitate use of keyboard equivalents, the Windows XP™ operating system has a “hotkeys” feature that permits a user to associate different software commands with key combinations specifically selected by the user and therefore easier to remember. The Skype application, for example, is compliant with this aspect of the Windows XP™ operating system, and a user is allowed to select keyboard equivalents to trigger several basic functions including answering a call, ignoring a call and rejecting a call. Although this approach is welcome, it is problematic, as a user remains obliged to learn and distinguish keyboard equivalents for several software applications.

It is also known in the design of keyboards to provide a button and supporting software dedicated to the launching of a particular software application from an inoperative state. This avoids the need to search the desktop or directories to find and then click an application icon. Extending such practices to provide multiple buttons dedicated to invoking various functions for a particular software application is also know. However this approach requires individual buttons for the various functions, which increases the size and complexity of the keyboard. As keyboard manufacturers are already constrained to limit the size of keyboards, especially for laptop computers or hand-held electronic devices this approach is impractical.

### SUMMARY

In accordance with an aspect of the present disclosure there is provided a method of controlling a current operating state of an application. The method comprising the steps of receiving an input event associated with the application, determining the current operating state of the application associated with the received input event, determining a successor state of the application based on the determined operating state and changing the current operating state of the application to the determined successor state.

In accordance with a further aspect of the present disclosure there is provided a computer program product for controlling a current operating state of an application. The computer program product comprising a computer readable medium embodying program code means for implementing a method comprising the steps of receiving an input event associated with the application, determining the current operating state of the application associated with the received input event, determining a successor state of the application based on the determined operating state, and changing the current operating state of the application to the determined successor state.

In accordance with a further aspect of the present disclosure there is provided a keyboard for communicating with a computing device, the keyboard comprising a button adapted to send an input event to the computing device for changing a current operating state of an application to a successor state of the application, the current operating state of the application and the successor state of the application selected from a plurality of possible operating states.

In accordance with a further aspect of the present disclosure there is provided a system for controlling a current operating state of an application, the system comprising a computing device and a keyboard. The computing device comprising a memory for storing instructions, a processor for executing the stored instructions, the executed instructions implementing an input component for receiving an input event associated with the application, a current operating state determination component for determining the current operating state of the application associated with the received input event, a successor state determination component for determining a successor state of the application based on the determined operating state and an operating state changing component for changing the current operating state of the application to the determined successor state. The keyboard device being coupled to the computing device. The keyboard device comprising a button adapted to send the input event associated with the application to the input component of the computing device.

### BRIEF DESCRIPTION OF THE DRAWINGS

The system and method for controlling the operating states of an application will be described with reference to drawings in which:

FIGS. 1a-1d are diagrammatic screen images stripped of detail and showing basic interface features characteristic of operating states;

FIG. 2a depicts in a block diagram, exemplary components of a system for controlling a current operating state of an application;

FIG. 2b depicts in a block diagram, exemplary logical components of a computing device for controlling a current operating state of an application;

FIG. 3 depicts in a fragmented perspective view, part of a keyboard device in accordance with the system and method for controlling a current operating state of an application;

FIG. 4 depicts in an exemplary block diagram the relationship among software and hardware component of the system for controlling a current operating state of an application;

FIG. 5 depicts in a flow chart, a method of controlling a current operating state of an application;

FIG. 6 depicts in an exemplary state transition diagram, operating states and transitions associated with the Windows™ applications;

FIG. 7 depicts in an exemplary flow chart, the steps of controlling a current operating state of an application;

FIG. 8 depicts in an exemplary state transition diagram, operating states and transitions associated with the Skype™ application;

FIG. 9 depicts in an exemplary flow chart, the steps of a method of controlling a current operating state of an application;

FIG. 10 depicts in a composite state diagram, both the operating system application states of the Skype™ application and the application-specific states characteristic of the Skype™ application; and

FIG. 11 depicts in a state table, sets of condition that effectively define the operating states associated with the Skype™ application. In the state diagrams, phantom lines are used to identify state transitions incidental to operation of the operating system or operation of a software application itself. Solid lines are used to indicate transitions occasioned by pressing a button dedicated to a particular application for purposes of controlling its operating states.

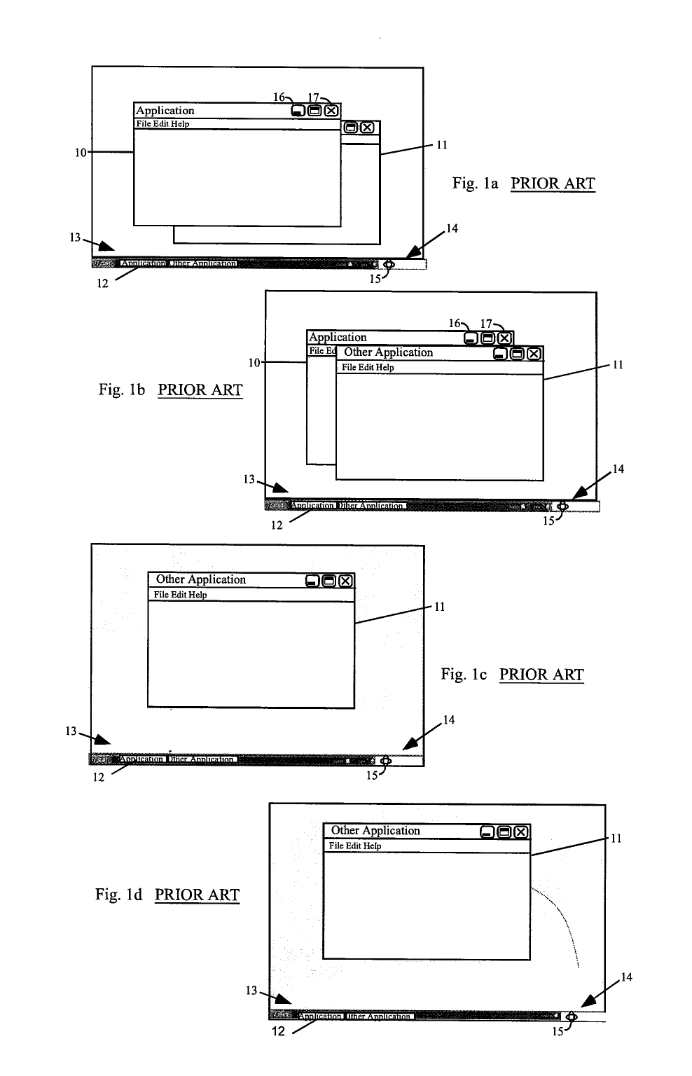

### DETAILED DESCRIPTION OF THE PREFERRED EMBODIMENTS

The system and method for controlling a current operating state of an application will be described with reference to the Windows XP™ operating system of Microsoft Inc. and to a now popular software application identified with the trademark Skype™ that enables telephone communication using a voice-over-internet protocol (“VOIP”). It should be understood, however, that the present system and method of controlling the current operating state of an application has application to other operating systems, such as the Apple Macintosh™ operating system, that have a graphic user interface comprising windows and menus and that permit use of a mouse to select commands found in menus or to trigger execution of procedures or scripts associated with buttons, and to computing devices that have applications.

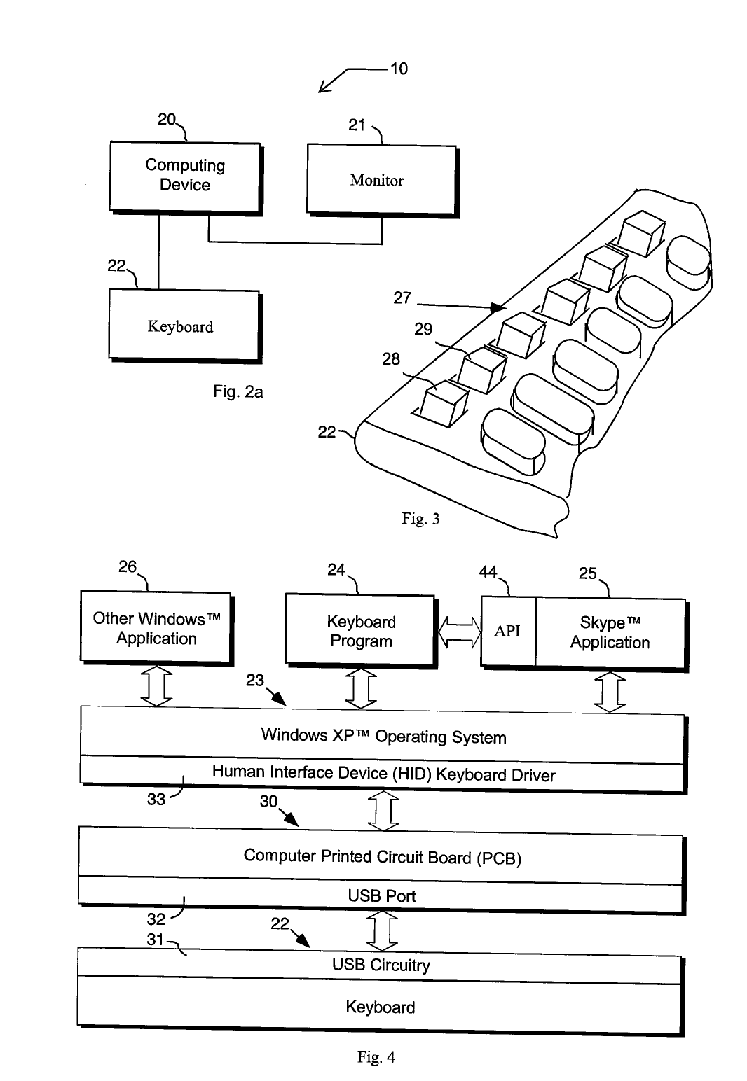

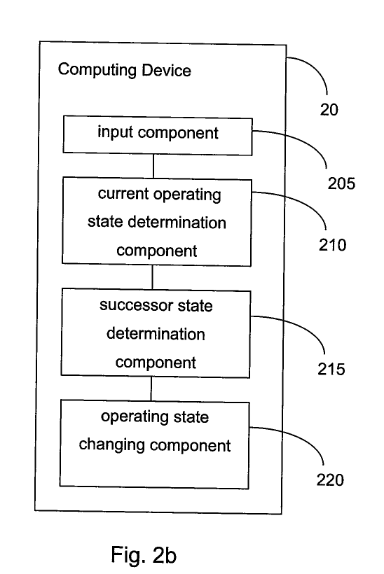

FIG. 2a depicts in a block diagram exemplary components of a system 10 for controlling a current operating state of an application. The system comprises a computing device 20. The computing device 20 is connected to a monitor 21 and a keyboard device 22 as further described herein.

FIG. 2b depicts in a block diagram, exemplary logical components of a computing device 20 for controlling a current operating state of an application. The computing device 20 comprises an input component 205 for receiving an input event associated with the application, a current operating state determination component 210 for determining the current operating state of the application associated with the received input event, a successor state determination component 215 for determining a successor state of the application based on the determined operating state and an operating state changing component 220 for changing the current operating state of the application to the determined successor state.

FIG. 3 depicts in a fragmented perspective view part of a keyboard device 22 in accordance with the system and method for controlling a current operating state of an application. The keyboard 22 comprises a set 27 of buttons along one side edge that are not standard. Each of the buttons 27 may typically be assigned to a different application for purposes of controlling its current operating state. For clarity of the description, one button 28 is assumed to have been dedicated to control of a Skype™ application 25, and another button 29, to the other Windows™ application 26.

FIG. 4 depicts in an exemplary block diagram the relationship among software and hardware component of the system 10 for controlling a current operating state of an application. The computing device 20 comprises a memory (not shown) for storing instructions and data, as well as a processor (not shown) for executing stored instructions. When executed by the processor the stored instructions may provide software for operating the computing device 20. The software may include the Window XP™ operating system 23, a custom keyboard program 24 that may load into RAM automatically on boot-up of the computing device 20, the Skype™ application 25, and another software application 26, which may be any Windows XP™ compliant software application and which is consequently referred to simply as the “other Windows™ application.”

Referring to FIG. 4, when either of the buttons 28, 29 are pressed, the keyboard 22 transmits a signal corresponding to the pressed button 28 or 29 to the computer's printed circuit board 30 via USB circuitry 31 associated with the keyboard 22 and a USB port 32 associated with the computer's circuit board 30. Initially a Human Input Device (HID) keyboard driver 33 associated with the operating system 23 handles the signal and generates an input event based on the signal. Since the signal is not a conventional keyboard signal, the custom keyboard program 24 ultimately receives the input event.

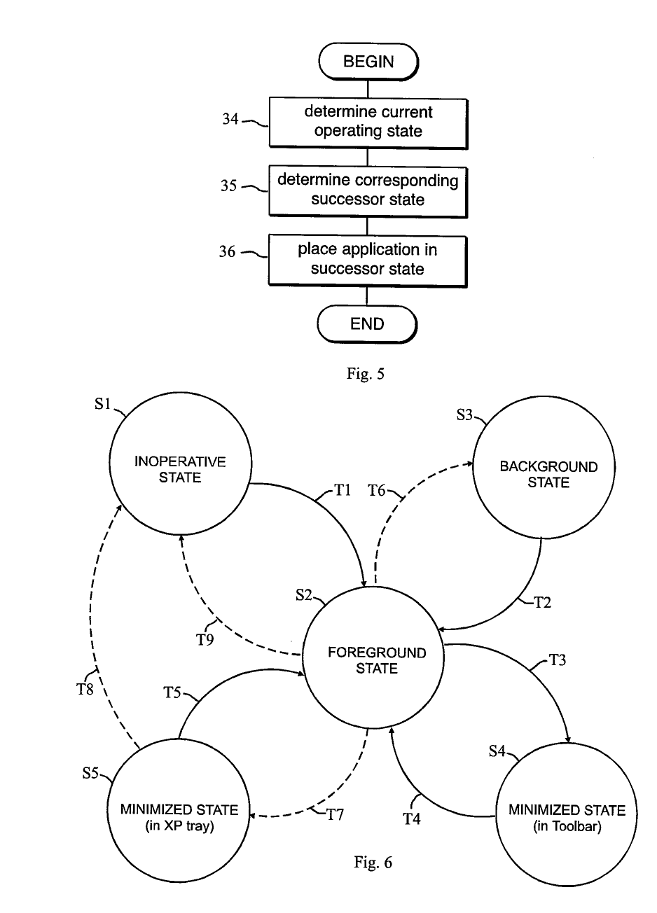

FIG. 5 depicts in a flow chart, a method of controlling a current operating state of an application. The method begins when the input event is received by the custom keyboard program 24. After receiving the input event, the keyboard program 24 determines the current operating state of the application, as at step 34. The keyboard program 24 may then accesses stored data identifying successor states for the operating states associated with the application, and determines an appropriate successor state corresponding to the current operating state, as at step 35. The keyboard program 24 then places the application in the successor state, changing the current operating state of the application to the determined successor state, as indicated at step 36. The successor state may optionally be set not only in response to the current operating state but one or more prevailing conditions as apparent from state diagrams and flow charts dealing with more specific implementations of described further herein.

FIG. 6 depicts in an exemplary state transition diagram, operating states and transitions associated with the other Windows™ application 26. The states of FIG. 6 are common to many Windows™ applications, as such they may be referred to as operating system application states. The system and method for controlling a current operating state of an application may be used advantageously to control the states of a Windows™ application. If the button 29 associated with the other Windows™ application has been pressed, only the operating system application states shown in FIG. 6 are involved in determining the successor state. The operating system application states include the inoperative state S1, the foreground state S2, the background state S3, and minimized states S4, S5. In the example depicted in FIG. 6, the foreground state S2 is identified as the successor state for each of the inoperative, background and both minimized states S1, S3, S4, S5. The successor state for the foreground state S2 is the minimized state S4 in the toolbar, and this allows a user to conveniently toggle between the foreground state S2, where input/output operations are directed to the other Windows™ application 26, and the minimized state S2, where the application 26 is essentially hidden, using a single button. This functionality allows access to windows (not shown) associated with other applications previously operating in the background. Each of the transitions T1-T5 between states S1-S5 involves a single tap of the assigned button 29. Several state transitions may be occasioned by operation of the other Windows™ application 26 or the operating system 23. For example, the transition T6 from the foreground state S2 to the background state S3 may be occasioned by launching a new application or by bringing another application into the foreground. Transition T7 from the foreground state S2 to the minimized state S5 in the XP tray may be occasioned when the user clicks on an X-button (not shown) associated with the window of the other Windows™ application 26. The transitions T8, T9 to the inoperative state may occur when the user exits the other Windows™ application 26. The operating state S5 in the XP tray will normally be restricted to particular applications designated to use the XP tray.

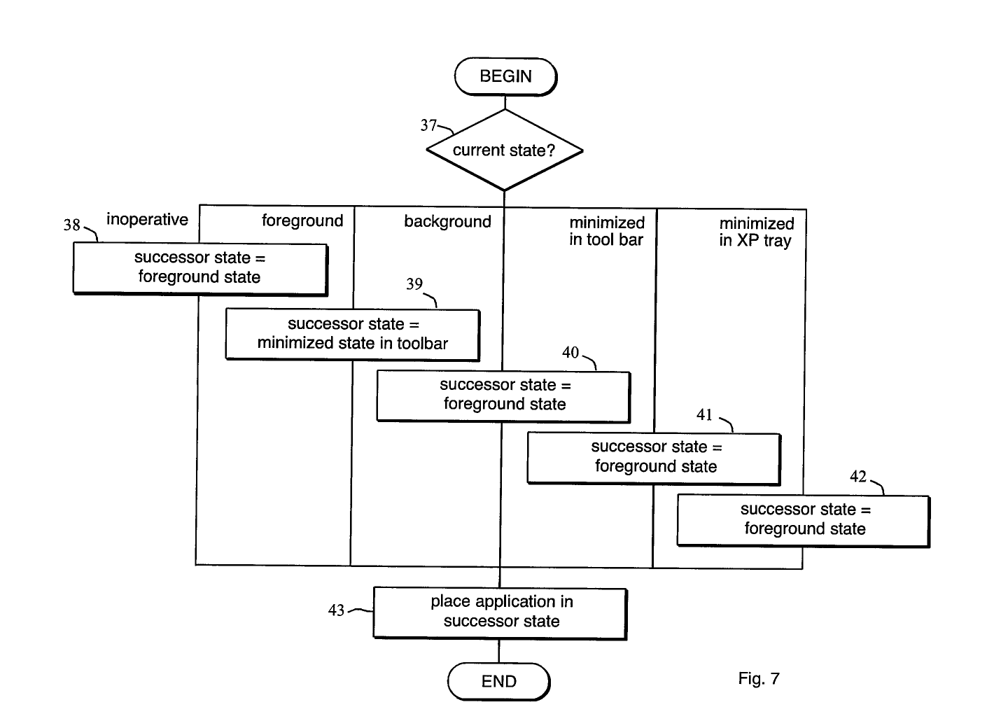

FIG. 7 depicts in an exemplary flow chart, the steps of controlling a current operating state of an application. In response to receiving an input event indicating the pressing of the button 29, the keyboard program 24 implements the steps of the flow chart shown in FIG. 7. After receiving the input event, the keyboard program 24 queries the operating system to determine the current operating state of the application associated with the input event, which will be an operating system application state, of the other Windows™ application 26, as at step 37. The keyboard program 24 then branches according to the determined current operating state, and an appropriate successor state is determined. The appropriate successor state may be determined using data stored in the software algorithm itself, as at steps 38, 39, 40, 41, 42. Alternatively, the data may be stored in a file or data structure in the memory of the computing device 20 (see FIG. 2a). Once the successor state has been determined, the other Windows™ application 26 is placed in the determined successor state, changing the current operating state of the application to the determined successor state, as at step 43. The changing of the current operating state of the application to the determined successor state may be accomplished by posting an event with the operating system 23 that requires the application either to come to the foreground or to minimize itself. This functionality is consequently available for use with all Windows XP™ compliant applications.

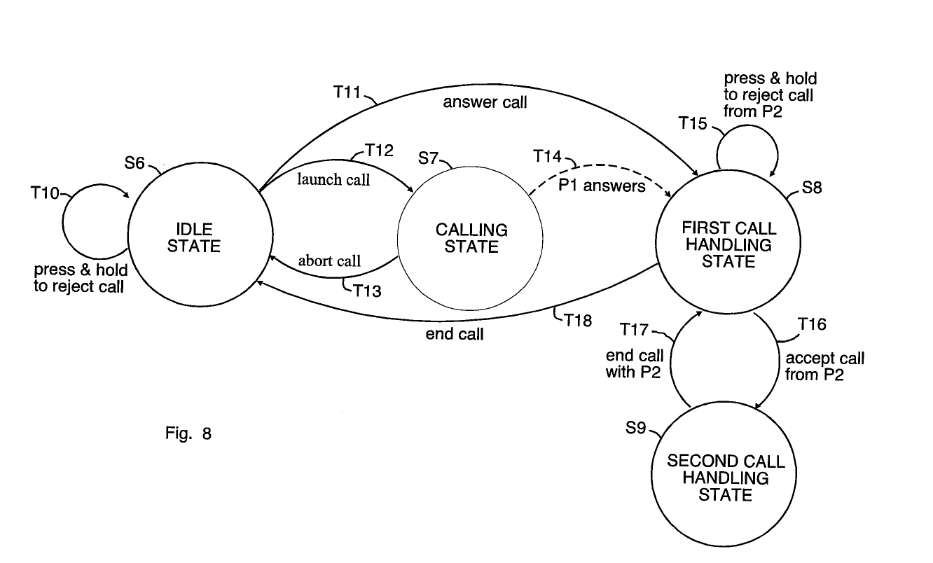

FIG. 8 depicts in an exemplary state transition diagram operating states and transitions associated with the Skype™ application 25. In addition to the operating system application states, an application may have its own different operating states, referred to as application-specific states. For example, the application-specific states of the Skype™ may include an idle state S6 in which the Skype™ application 25 is executing but not engaged in handling of a telephone call, a calling state S7 in which the software dials a specified telephone number and attempts to complete a telephone connection, a first call-handling state S8 in which the software enables a telephone conversation with a first person (identified only as “P1” in the flowcharts) who is either an outside caller or the recipient of an outgoing call, and a second call-handling state S9 in which the software places the first person P1 on hold and enables a telephone conversation with a second person (identified only as “P2” in the drawings) who may be an outside caller. An input event indicating a single tap of the button 28 assigned to the Skype™ application may cause the state transitions T11-T14 and T16, T17.

The overall operation occasioned with each such state transition is identified in FIG. 8 adjacent to the curved line representing the transition. It is understood that a state transition may be occasioned by changing the current operating state of an application to a successor state. For example, state transition T11 involves answering a call from an outside caller, as indicated by the expression “answer call” adjacent to the state transition T1. State transition T14 is occasioned by inherent operation of the Skype™ application 25, which automatically moves the Skype™ application from its calling state S7 to its first call-handling state S8 in response to the person P1 answering the outgoing call. Transitions T10 and T15 are circular indicating that the Skype™ application 25 remains in its then current operating state. Such transitions may be triggered by receiving an input event indicating that the assigned button 28 has been pressed and held, for example, for about 1.5 seconds. Such operation of the assigned button 28 very conveniently adds functionality, which may indicate the user's intention to reject an incoming call in the idle state S6 or to reject an incoming call from a second person P2 in the first call-handling state S8. The Skype™ application 25 is made to respond accordingly. This is achieved by communicating with the Skype™ application 25 through an application program interface (API) 44 (see FIG. 4), which is associated with the Skype™ application 25.

The AP 44I may be used to determine the application-specific state of the Skype™ application, which may be used in determining the current operating state in stead of, or in addition to, the operating system application states. The API 44 can be queried to identify various conditions, for example, whether the Skype™ application is currently idle, whether the user has specified a telephone number that is to be dialed, whether there is currently an incoming call, whether the Skype™ application 25 is currently handling a call, and whether a second, incoming call is detected during handling of a current call. Similarly, state transitions in the Skype™ application 25 are triggered through the API 44, changing the current operating state of the Skype™ application.

At least one advantage achieved is that the Skype™ application 25 can be stepped through its various operating states, accepting, rejecting, and handling calls, by simply pressing the assigned button 28. The user is not obliged to learn various key equivalents but progresses naturally between states by operating a single button 28. Furthermore, only a single button on the keyboard is required to achieve the changing of the operating states of the application, which may reduce the size of the keyboard.

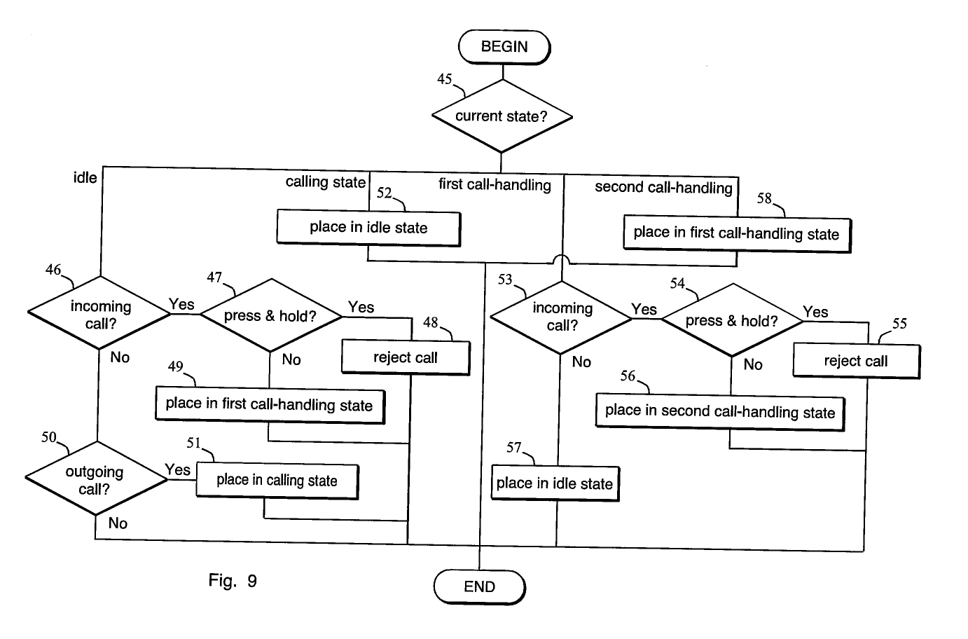

FIG. 9 depicts in an exemplary flow chart, the steps of a method of controlling a current operating state of an application. In response to receiving an input event indicating the pressing of the button 28, the keyboard program 24 implements the steps of the flow chart shown in FIG. 9. After receiving the input event, the keyboard program 24 queries the API 44 to determine the current operating state, which may be an application-specific state, of the Skype™ application 26, as at step 45. Once the current operating state has been determined the keyboard program 24 branches accordingly. If the Skype™ application 25 is in its idle state S6, the program queries the API 44 to determine whether there is an incoming call (step 46). If so, it determines whether the received input event indicates that the user has pressed and is holding the button 28 down (step 47). If that condition is met, the program instructs the Skype™ application 25 via the API 44 to reject the call (step 48). Otherwise, the program places the Skype™ application 25 in its first call-handling state (step 49). If there is currently no incoming call, the program queries the API 44 to determine whether an outgoing call has been specified (step 50), and accordingly places the Skype™ program, through the API 44, in its calling state S7 (step 51).

If the Skype™ application 25 is in its calling state S7 when the input event is received indicating that the button 28 is pressed, the keyboard program 24 instructs the Skype™ application 25 via the API 44 to change its current operating state to its idle state, incidentally canceling the outgoing call, as at step 52.

If the Skype™ application 25 is in its first call-handling state when the input event is received indicating that the button 28 is pressed, the keyboard program 24 uses the API 44 to determine if there is an incoming call from a second person P2 (step 53). If so, the keyboard program 24 checks whether the input event is received indicating that the user is holding the button 28 down (step 54), and if so, instructs the Skype™ application 25 via its interface to reject the call (step 55). Otherwise, the program places the Skype™ application 25 via its API 44 into its second call-handling state (step 56), incidentally placing the first person P1 on hold and enabling a conversation with the second person P2. Otherwise, with no incoming call, the keyboard program 24 assumes the user wishes to end the current conversation with the person P1, and changes the current operating state of the Skype™ application 25 to the determined successor state which is the idle state S6 as at step 57.

If the Skype™ application 25 is in its second call-handling state with a first person P1 on hold when the input event is received indicating the button 28 is pressed, the keyboard program 24 assumes that the user wishes to end his conversation with person P2. It then instructs the Skype™ application 25 via the API 44 to return to its first calling state (step 58), incidentally terminating the call with the person P2 and once again enabling conversation with the person P1.

As described above the current operating state and the successor state of an application (whether the other Windows™ application or the Skype™ application) may be selected from a possible set of operating states. The possible operating states may include operating system application states and/or application-specific states.

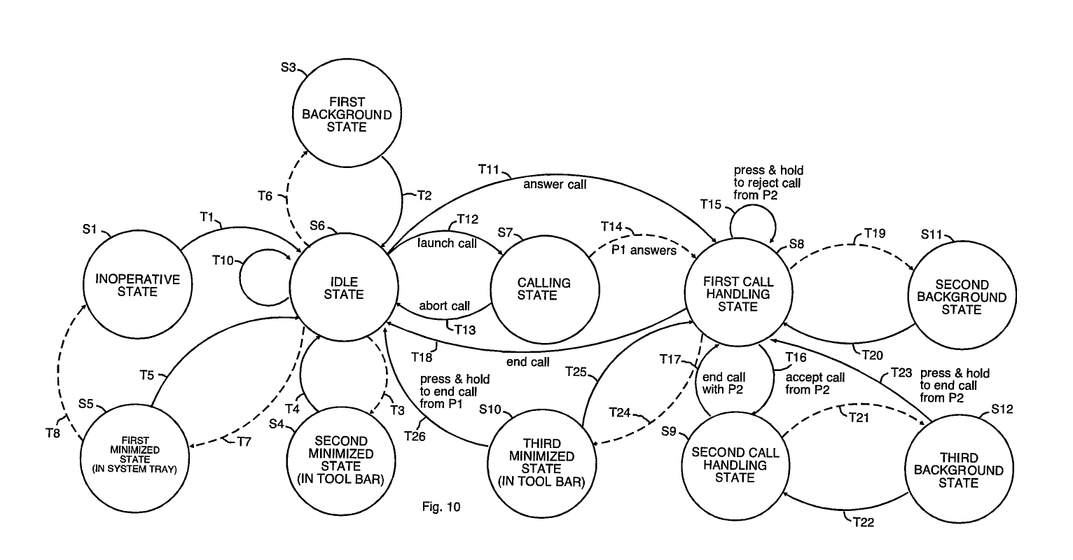

FIG. 10 depicts in a composite state diagram, both the operating system application states of the Skype™ application 25 (common to all Windows XP™ applications) and the application-specific states characteristic of the Skype™ application 25 itself. Several aspects of the diagram should be noted. First, reference labels used in the state diagrams of FIGS. 6 and 8 have been preserved in FIG. 10, and the description above of corresponding states and transitions is applicable and will not be repeated. The idle state S6 of the Skype™ application 25 as identified in FIG. 10 corresponds to the foreground state S2 illustrated in FIG. 6. Transitions T1-T7 of FIG. 6 are now shown to and from the idle state S6. The Skype™ application 25 has not only the two minimized states S4, S5 shown in FIG. 4 but also a third minimized state S10. In addition to the background state S3 of FIG. 6, there are now two additional background states, a second background state S11 and a third background state S12.

A transition T19 from the first call-handling state S8 to the second background state S11 occurs when the Skype™ application 25 is placed in the background by user actions that bring another application to the foreground. A transition T20 from the second background state S11 back to the first call-handling state S8 is caused by tapping the assigned button 28 but also occurs automatically when the Skype™ application 25 responds to an incoming call from a second person P2 while a first person P1 is on hold. A transition T21 from the second call-handling state S9 to the third background state S12 occurs when user action brings another application to the foreground, and a transition T22 from the third background state S13 back to the second call-handling state S9 is caused by tapping the assigned button 28. In the third background state S12, a user can terminate a conversation with a second person P2 by pressing and holding the assigned button 28, which causes a transition T23 to the first calling-handling state S8 where the user can once again converse with a first person P1 who has been on hold.

The Skype™ application 25 makes a transition T24 from its first call-handling state S8 to its third minimized state S10 in response to clicking on a minimize button in the application window. Once in the third minimized state S10, the Skype™ application 25 makes a transition T25 back to its first call-handling state S8 in response to the user tapping the assigned button 28 or automatically in response to detection of an incoming call from a second person P2. In the third minimized state, the user can press and hold the assigned button 28 to end a telephone conversation with a first person P1 in which case the Skype™ application 25 makes a transition T26 back to the idle state S6.

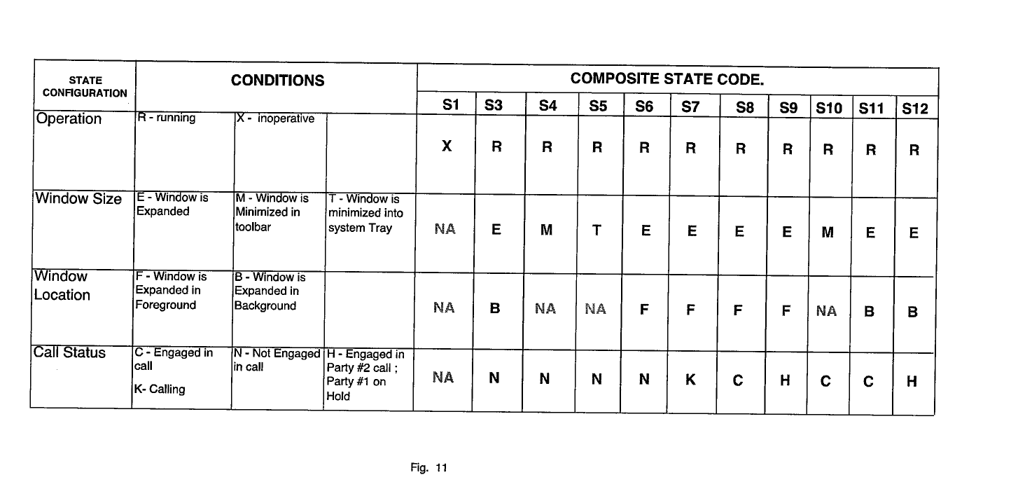

FIG. 11 depicts in a state table, sets of condition that effectively define the eleven operating states S1, S3-S12 associated with the Skype™ application 25. Under the heading “CONDITIONS” are three columns in which codes are assigned to various conditions. These codes are used under the heading “COMPOSITE STATE CODE” to identify the characteristics of each state. For instance, the column with the heading “S6” contains four codes defining the characteristics of the idle state S6: (1) “R” which identifies that the Skype™ application 25 is running and not inoperative; (2) “E” which identifies that the application window associated with the Skype™ application 25 is expanded (the application has not been minimized); (3) “F” which identifies that the Skype™ application 25 is in the foreground; and (4) “N” which identifies that the Skype™ application 25 is not handling a telephone call. The code “NA” identifies that a particular characteristic is not applicable to a particular operating state.

The system and method for controlling a current operating state of an application has particular application to applications running on operating systems that provide operating system application states to applications, such as for example a calculator, web browser, email program etc. The operating system application states may include, for example, non-operative, foreground, background and minimized states of operation corresponding to those described above with reference to the Window XP™ operating system. To that end, data may be stored, for example to identify the foreground state of an application as the successor state to each of the non-operative state, background and minimized states. One minimized state may be identified as the successor state of the foreground state, which then allows toggling of the application between foreground and minimized states with repeated pressing of the assigned button.

The system and method for controlling a current operating state of an application also has particular application to applications that have different operating states, for example, communication software applications adapted to implement VOIP telephone communication, such as the Skype™ software application discussed above. Such software may have operating system application states as mentioned above but will also have application-specific states associated with, for example, telecommunication functions. The application-specific states may include an idle state in which the software application is executing but not engaged in handling of a telephone call; a calling state in which the software application dials a specified telephone number and attempts to complete a telephone connection; a first call-handling state in which the software application enables a telephone conversation with a first person, and a second call-handling state in which the software places the first person on hold and enables a telephone conversation with a second person who happens to call. In such a context, the data to be stored may identify the calling state as a successor to the idle state if the assigned button is pressed while a telephone number for an outgoing telephone call is specified. The first call-handling state may be identified as a successor to the idle state if the button is pressed during an incoming call, and the idle state may be identified as a successor to both call-handling states. More specifically, the idle state is identified as the successor to the first call-handling state if the assigned button is pressed while there is no incoming call; the second call-handling state is identified as a successor to the first call-handling state if the assigned button is pressed in response to a second person making an incoming call; and the first call-handling state may be identified as a successor to the second call-handling state. The advantage obtained is that the user can step the application through various operating states, handling incoming and outgoing telephone calls, with just a single button.

Although the system and methods have been described in detail with reference to a computing device and keyboard, it is understood that the system and methods may be advantageously used in other devices, such as for example, a cell phone, a personal digital assistant (PDA), a smart phone, etc. For example, a cell phone may utilize the system and methods described herein to replace multiple buttons used for initiating a call and ending a call with a single button that determines the operating state of the cell phone determines a possible successor state to place the phone in depending on at least the determined operating state, and then places the cell phone in the determined possible successor state.

The system and methods according to the present patent disclosure may be implemented by any hardware, software or a combination of hardware and software having the above described functions. The software code, either in its entirety or a part thereof, may be stored in a computer-readable memory. Further, a computer data signal representing the software code which may be embedded in a carrier wave may be transmitted via a communication network. Such a computer-readable memory and a computer data signal are also within the scope of the present patent disclosure, as well as the hardware, software and the combination thereof.

While particular embodiments of the present patent disclosure have been shown and described, changes and modifications may be made to such embodiments without departing from the true scope of the patent disclosure.

What is claimed is:

1. A method of controlling a current operating state of an application, the method comprising the steps of:
receiving an input event associated with the application;
determining the current operating state of the application associated with the received input event;
determining a successor state of the application based on the determined operating state; and
changing the current operating state of the application to the determined successor state.

2. The method as claimed in claim 1, wherein the determined current operating state of the application and the determined successor state of the application are determined from a plurality of possible operating states.

3. The method as claimed in claim 2, wherein the plurality of possible operating states comprise:
a non-operative state in which the application is not executing;
a foreground state in which the application is executing in the foreground;
a background state in which the application is executing in the background; and
a minimized state in which the application is paused with no window associated with the application displayed on the monitor.

4. The method as claimed in claim 3, wherein the step of determining the successor state of the application comprises selecting:
the foreground state as the successor state when the current operating state is the non-operative state;
the foreground state as the successor state when the current operating state is the background state;
the foreground state as the successor state when the current operating state is the minimized state; and,
the minimized state as the successor state when the current operating state is the foreground state.

5. The method as claimed in claim 2, in which the application is adapted to implement voice-over-internet protocol telephone communication and wherein the plurality of possible operating states comprise:
an idle state in which the application is executing but not engaged in handling of a telephone call;
a calling state in which the application dials a telephone number and attempts to complete a telephone connection;
a first call-handling state in which the application enables a telephone conversation with a first person; and
a second call-handling state in which the application places the first person on hold and enables a telephone conversation with a second person who is an outside caller.

6. The method as claimed in claim 5, wherein the step of determining the successor state of the application comprises selecting:
the calling state as the successor state if the current operating state is the idle state and the input event is received while a telephone number for an outgoing telephone call is specified;
the first call-handling state as the successor state if the current operating state is the idle state and the input event is received during an incoming call;
the idle state as the successor state if the current operating state is the calling state;
the idle state as the successor state if the current operating state is the first call-handling state and the input event is received while there is no incoming call;
the second call-handling state as the successor state if the current operating state is the first call-handling state and the input event is received during a second incoming call; and
the first call-handling state as the successor state if the current operating state is the second call-handling state.

7. The method as claimed in claim 2, wherein the plurality of possible operating states comprise at least one of:
operating system application states; and
application-specific states.

8. The method as claimed in claim 7, wherein the step of determining the current operating state of the application comprises at least one of:
querying an operating system to determine an operating system application state of the application; or
querying the application to determine an application-specific state of the application.

9. The method as claimed in claim 1, wherein the step of receiving the input event associated with the application comprises:
receiving an input indicating the tapping of a button associated with the application; or
receiving an input indicating the pressing and holding of the button associated with the application.

10. The method as claimed in claim 1, further comprising the steps of:
assigning a predetermined button of a keyboard to the input event; and
storing data that associates each possible successor state with the possible operating state and the state transition requirements.

11. A computer program product for controlling a current operating state of an application, the computer program product comprising a computer readable medium embodying program code means for implementing a method comprising the steps of:
receiving an input event associated with the application;
determining the current operating state of the application associated with the received input event;
determining a successor state of the application based on the determined operating state; and
changing the current operating state of the application to the determined successor state.

12. A keyboard for communicating with a computing device, the keyboard comprising a button adapted to send an input event to the computing device for changing a current operating state of an application to a successor state of the application, the current operating state of the application and the successor state of the application selected from a plurality of possible operating states.

13. A system for controlling a current operating state of an application, the system comprising:
a computing device comprising:
a memory for storing instructions;
a processor for executing the stored instructions, the executed instructions implementing:
an input component for receiving an input event associated with the application;
a current operating state determination component for determining the current operating state of the application associated with the received input event;
a successor state determination component for determining a successor state of the application based on the determined operating state; and
an operating state changing component for changing the current operating state of the application to the determined successor state; and
a keyboard device coupled to the computing device, the keyboard device comprising:
a button adapted to send the input event associated with the application to the input component of the computing device.

14. The system as claimed in claim 13, wherein the determined current operating state of the application, and the determined successor state of the application are determined from a plurality of possible operating states, the plurality of possible operating states comprise:
a non-operative state in which the application is not executing;
a foreground state in which the application is executing in the foreground;
a background state in which the application is executing in the background; and
a minimized state in which the application is paused with no window associated with the application displayed on the monitor; and
wherein determining the successor state of the application comprises selecting:
the foreground state as the successor state when the current operating state is the non-operative state;
the foreground state as the successor state when the current operating state is the background state;
the foreground state as the successor state when the current operating state is the minimized state; and,
the minimized state as the successor state when the current operating state is the foreground state.

15. The system as claimed in claim 13, wherein the application is adapted to implement voice-over-internet protocol telephone communication; wherein the determined current operating state of the application, and the determined successor state of the application are determined from a plurality of possible operating states, the plurality of possible operating states comprise:
an idle state in which the application is executing but not engaged in handling of a telephone call;
a calling state in which the application dials a telephone number and attempts to complete a telephone connection;
a first call-handling state in which the application enables a telephone conversation with a first person; and
a second call-handling state in which the application places the first person on hold and enables a telephone conversation with a second person who is an outside caller; and
wherein determining the successor state of the application comprises selecting:
the calling state as the successor state if the current operating state is the idle state and the input event is received while a telephone number for an outgoing telephone call is specified;
the first call-handling state as the successor state if the current operating state is the idle state and the input event is received during an incoming call;
the idle state as the successor state if the current operating state is the calling state;
the idle state as the successor state if the current operating state is the first call-handling state and the input event is received while there is no incoming call;
the second call-handling state as the successor state if the current operating state is the first call-handling state and the input event is received during a second incoming call; and
the first call-handling state as the successor state if the current operating state is the second call-handling state.
